(19) United States
(12) Patent Application Publication
(10) Pub. No.: US 2008/0097667 A1
(43) Pub. Date: Apr. 24, 2008

(54) Method And Device For Determining A Steering Angle In A Motor Vehicle

(76) Inventors: Peter Brenner, Mogglingen (DE); Gerd Reimann, Abstatt (DE); Wolfgang Reinelt, Stuttgart (DE); Thoma Achim, Bergrheinfeld (DE); Andreas Gartner, Aachen (DE)

Correspondence Address: MCGLEW & TUTTLE, PC, P.O. BOX 9227, SCARBOROUGH STATION, SCARBOROUGH, NY, 10510-9227, US

(21) Appl. No.: 11/718,785

(22) PCT Filed: Nov. 2, 2005
(86) PCT No.: PCT/EP05/55703

§ 371 Date: May 7, 2007

(30) Foreign Application Priority Data
Nov. 6, 2004 (DE) 10 2004 053 690.2

(51) Int. Cl. B62D 15/02; B62D 113/00

(52) U.S. Cl. 701/41; 280/93.5

(57) ABSTRACT

The invention relates to a device and method for determining a steering angle of a motor vehicle. The systems make it possible to detect an elastokinematic angle on at least one steering pivoting joint (10) in correlation with a wheel offset.

### CROSS REFERENCE TO RELATED APPLICATIONS

This application is a United States National Phase application of International Application PCT/EP2005/055703 and claims the benefit of priority under 35 U.S.C. § 119 of German Patent Application DE 10 2004 053 690.2 filed Nov. 6, 2004, the entire contents of which are incorporated herein by reference.

### FIELD OF THE INVENTION

The present invention pertains to a sensor device for determining a steering angle in a motor vehicle. The present invention also pertains to a corresponding method.

### BACKGROUND OF THE INVENTION

Optical or magnetoresistive steering angle sensors, which are used to detect the travel direction command preset by the driver, are increasingly used in motor vehicles in the area of the steering column or the steering wheel. Such sensors are based mostly on an optical or magnetoresistive principle of measurement.

The information on the steering angle, which is derived from the output signal of the steering angle sensor, is subsequently used as an input variable of various systems of the vehicle, for example, an ABS/ESP system or an electric power steering.

A steering angle sensor with a combination of a mechanical counting means and an optical code disk, which is scanned within one revolution of the steering wheel, is described in DE 101 10 785 C2 for determining the absolute angle of rotation.

A counting unit for counting the full revolutions of the steering wheel in the form of an intermittent motion is known from DE 196 01 965 A1.

It is proposed in DE 100 57 674 A1 that the path of displacement of the toothed rack of a steering gear, which is caused by the turning angle of the steering wheel, be detected to determine the absolute steering angle. The steering angle can thus be inferred from the transmission ratio of the steering wheel angle to the linear motion of the toothed rack.

DE 100 64 630 A1 discloses a steering knuckle pin bearing, in which an angle of rotation sensor, which detects a relative rotation between an inner pot and an outer pot, is integrated in the bearing cartridge.

DE 698 09 136 T2 discloses a possibility of protecting a vehicle sensor by means of a sealing material. The vehicle sensor is designed as a potentiometer, the potentiometer being arranged on a carrier or on the track rods of a forklift.

Multiturn steering angle sensors can be used to unambiguously determine the current steering angle from a motion of the steering wheel over up to three full revolutions. However, mostly steering angle sensors that cannot scan the entire possible steering angle range of up to three revolutions of the steering wheel unambiguously are used because of the high cost of multiturn-capable sensor systems.

Due to their design and the type of the detector elements, so-called single-turn steering angle sensors can unambiguously scan only a full revolution of 360° or part thereof, for instance, 180°.

The determination of the absolute steering angle over the entire possible steering angle range can be carried out with other physical measured variables available from the vehicle, e.g., the number of revolutions of the individual wheels of the vehicle. This method has the drawback that a certain distance traveled or velocity of travel is necessary to make possible the unambiguous determination of the steering angle.

### SUMMARY OF THE INVENTION

The basic object of the present invention is to provide a means and a method for determining absolute steering angle information in a motor vehicle.

According to the invention, a motor vehicle steering system is provided comprising a steering wheel and a steering angle sensor arranged for sensing changes in steering angle of the steering wheel in angle range of the steering wheel and generating a corresponding steering angle signal. A steering joint is provided that is connected to a vehicle wheel. The steering joint has a steering joint movement range corresponding with a movement range of the vehicle wheel. An angle sensor is provided for sensing change in angular position of the steering joint and providing an angular position signal that is within an unambiguous signal range related to the steering joint movement range. Means are provided for correlating the steering angle signal of the steering angle sensor with the unambiguous signal range of the integrated angle sensor system based on the angular position signal for determining unambiguous steering angle information from the steering angle signal.

According to another aspect of the invention, a sensor device is provided for determining steering angle information in a motor vehicle. The device comprises a steering angle sensor arranged in the angle range of a rotatable steering element of a steering system. The steering angle sensor is for detecting a travel direction command introduced by means of a steering handle (steering wheel). An elastokinematic angle means is provided for detecting elastokinematic angles at a steering joint having a movement correlated with the excursion of a vehicle.

The elastokinematic angle means for the detection of elastokinematic angles may comprise an integrated angle sensor system having a corresponding pair of optical or magnetic transducers and detectors. The integrated angle sensor system may be arranged in the steering joint of a track rod.

According to another aspect of the invention, a method is provided for determining steering angle information. The method comprises arranging a steering angle sensor in the angle range of a rotatable steering element of a steering system and detecting elastokinematic angles with an integrated angle sensor system at a steering joint having a movement correlated with the excursion of a vehicle wheel to provide an unambiguous signal range. Steering angle signals of the steering angle sensor are made plausible with an unambiguous signal range of the integrated angle sensor system. Unambiguous steering angle information is determined therefrom.

The signal of the steering angle sensor may be ambiguous over a total possible steering range and is then made plausible with the unambiguous signal range of the integrated angle sensor system for determining unambiguous steering angle information. The signal of the steering angle sensor may be unambiguous over a total possible steering range and is then made plausible with the unambiguous signal range of the integrated angle sensor system for determining unambiguous steering angle information.

The steering angle information is advantageously sent to an electronic system of the vehicle. A computer program with program code means to carry out a method in accordance with the invention may be provided. A computer system may be provided, especially a control device for operating an electric power steering in a motor vehicle, on which the mentioned computer program is executed.

Advantageous embodiments are disclosed and a corresponding computer program with program code means is provided as well. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic partially sectional view showing an embodiment of an integrated angle sensor arranged in a ball and socket joint according to the invention;

FIG. 2 is a schematic view showing an embodiment according to the invention of a front axle steering system in a vehicle, with a steering wheel, a steering angle sensor and a power steering arrangement and an integrated angle sensor arranged or integrated in the steering joint which is the head-side angle joint of a track rod; and

FIG. 3a is a diagram relating to an exemplary embodiment of the method according to the present invention; and

FIG. 3b is another diagram relating to the exemplary embodiment of the method according to the present invention.

### DESCRIPTION OF THE PREFERRED EMBODIMENTS

Referring to the drawings in particular, the present invention is based on the idea of providing additional means for detecting elastokinematic angles on a steering joint 10 of the steering system for determining absolute steering angle information in a motor vehicle with a steering angle sensor arranged in the range of action of a rotatable steering element of a steering system 8.

An integrated angle sensor known from the state of the art can be used to detect elastokinematic angles.

An integrated angle sensor system is arranged according to the present invention in a suitable steering joint of the wheel control arms of a steerable front axle or rear axle. It is self-explanatory that the excursion of the corresponding steering joint must correlate with the excursion of the wheel.

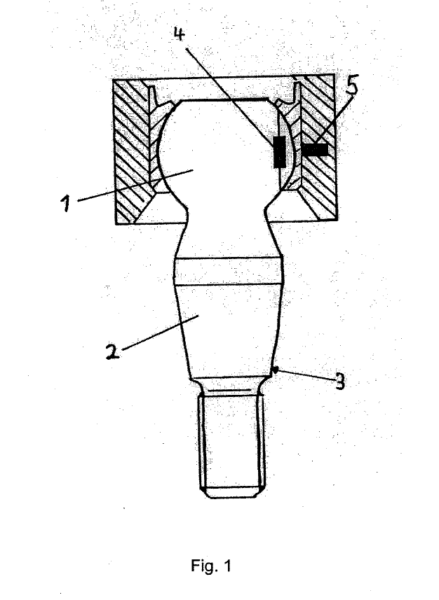

FIG. 1 shows as an example an embodiment of an integrated angle sensor 4, 5 as it can be arranged in a ball and socket joint:

The joint is in the form of a ball pivot 3 comprising a joint ball 1, a pivot 2 and the magnetic field transducer 4 arranged therein in a suitable manner. A magnetic field detector 5 is in magnetic functional connection therewith. The arrangement shown is able to detect relative angular motions of the magnetic field transducer 4 and of the magnetic field detector 5 about the longitudinal axis of the ball pivot 3. The integrated angle sensor 4, 5 may also be based on an optical principle of measurement, comprising a corresponding pair of optical transducers and detectors, instead of on a magnetic principle of measurement, comprising magnetic field transducers and magnetoresistive receiver elements.

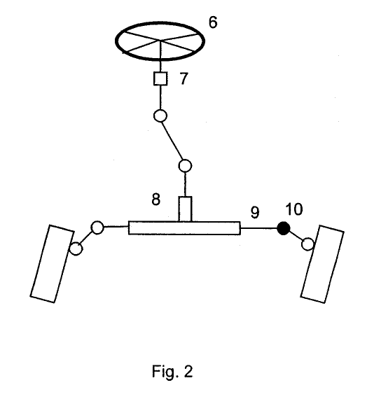

FIG. 2 schematically shows the design of a front axle steering system in a vehicle, with a steering wheel 6, a steering angle sensor 7 and a power steering 8. The integrated angle sensor is arranged or integrated in the exemplary embodiment being shown at the steering joint 10, which is the head-side angle joint of a track rod 9.

The method according to the present invention makes provisions for the signal of a steering angle sensor 7 to be made plausible with (correlated with) an unambiguous signal range of the integrated angle sensor 4, 5 in order to determine unambiguous steering angle information 4, 5 from the signal of a steering angle sensor 7.

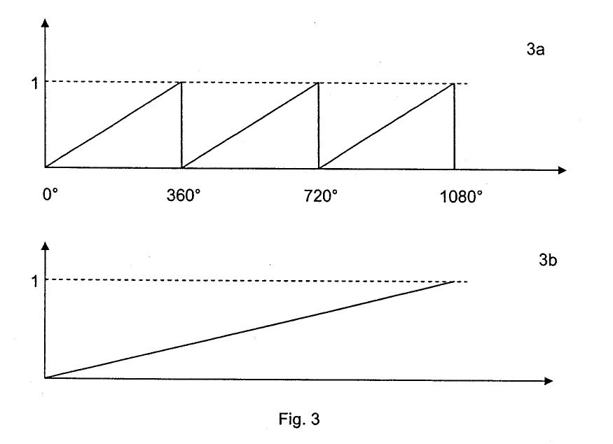

FIGS. 3a and 3b show aspects of an exemplary embodiment of the method and system according to the present invention.

The relationship shown in the graph of FIG. 3a shows angle information of a corresponding signal of a steering angle sensor, which information is standardized for the value 1. It can be recognized that the angle information of the steering angle sensor is ambiguous over the entire possible steering angle range of, for example, three full revolutions.

The relationship shown in the graph FIG. 3b shows angle information of a corresponding signal of an integrated angle sensor 4, 5, which information is standardized for the value 1. It can be recognized that the angle information of the integrated angle sensor system 4, 5 is unambiguous over the possible range of excursion of the steering joint.

It is apparent that the signal sent by the integrated angle sensor system 4, 5 can always be scanned to (correlated to) a value within the possible angle range of the steering joint 10.

Provisions are made in an exemplary embodiment of the method according to the present invention for making plausible a signal that is ambiguous over the entire possible steering angle range or an ambiguous angle information of a steering angle sensor 7, which information was derived therefrom. The unambiguous angle information derived from an unambiguous signal of the integrated angle sensor system 4, 5 in order to determine an unambiguous steering angle information therefrom.

Another exemplary embodiment, for which no figure is provided, makes provisions for making plausible a signal that is unambiguous over the entire possible steering angle range or an unambiguous angle information of a steering angle sensor, which information is derived therefrom, with unambiguous angle information derived from an unambiguous signal of the integrated angle sensor system 4, 5 in order to determine or verify an unambiguous steering angle information therefrom.

The overall behavior of the steering system in the vehicle can advantageously also be checked functionally thereby. The method may also be used, in principle, in superposition steerings, in which case the feed angle introduced additively by means of a superposition gear must be correspondingly taken into account.

Another advantage of the present invention is that the determination of the absolute steering angle information is made possible when the vehicle is stopped, i.e., immediately after the run-up phase of an electronic control device, and without the necessity to move the vehicle, which requires a difference measurement of wheel rotation or velocity information. The problem in regard to the evaluation of such information during travel on a background of low coefficient of friction or spinning wheels is thus eliminated as well.

Absolute steering angle information determined according to the method according to the present invention can be subsequently sent to other electronic systems of the vehicle.

While specific embodiments of the invention have been shown and described in detail to illustrate the application of the principles of the invention, it will be understood that the invention may be embodied otherwise without departing from such principles.

1. A sensor device for determining steering angle information in a motor vehicle, the device comprising:
a steering angle sensor arranged in the angle range of a rotatable steering element of a steering system (8), said steering angle sensor for detecting a travel direction command introduced by means of a steering handle
elastokinematic angle means for detecting elastokinematic angles at a steering joint having a movement correlated with the excursion of a vehicle wheel.

2. A sensor device in accordance with claim 1, wherein said elastokinematic angle means for the detection of elastokinematic angles comprises an integrated angle sensor system having a corresponding pair of optical or magnetic transducers and detectors.

3. A sensor device in accordance with claim 1, wherein the integrated angle sensor system is arranged in a steering joint of a track rod.

4. A method for determining steering angle information, the method comprising the steps of:
arranging a steering angle sensor in the angle range of a rotatable steering element of a steering system;
detecting elastokinematic angles with an integrated angle sensor system at a steering joint having a movement correlated with the excursion of a vehicle wheel to provide an unambiguous signal range;
making steering angle signals of said steering angle sensor plausible with an unambiguous signal range of the integrated angle sensor system; and
determining unambiguous steering angle information from the steering angle signals made plausible.

5. A method for determining steering angle information according to claim 4, wherein the signal of said steering angle sensor is ambiguous over a total possible steering range and is made plausible with the unambiguous signal range of the integrated angle sensor system for determining unambiguous steering angle information.

6. A method for determining steering angle information according to claim 4, wherein the signal of said steering angle sensor is unambiguous over a total possible steering range and is made plausible with the unambiguous signal range of the integrated angle sensor system for determining unambiguous steering angle information.

7. A method in accordance with claim 4, wherein the steering angle information is sent to an electronic system of the vehicle.

8. A computer program with program code means to carry out a method in accordance with claim 4.

9. (canceled)

10. A method in accordance with claim 5, wherein the steering angle information is sent to an electronic system of the vehicle.

11. A method according to claim 4, wherein a computer program with program code means is provided for said steps of making steering angle signals of said steering angle sensor plausible with an unambiguous signal range of the integrated angle sensor system and determining unambiguous steering angle information from the steering angle signals made plausible.

12. A method according to claim 5, wherein a computer program with program code means is provided for said steps of making steering angle signals of said steering angle sensor plausible with an unambiguous signal range of the integrated angle sensor system and determining unambiguous steering angle information from the steering angle signals made plausible.

13. A motor vehicle steering system comprising:
a steering wheel;
a steering angle sensor arranged for sensing changes in steering angle of said steering wheel in angle range of said steering wheel and generating a corresponding steering angle signal;
a steering joint connected to a vehicle wheel and having a steering joint movement range corresponding with a movement range of the vehicle wheel;
an angle sensor for sensing change in angular position of said steering joint and providing an angular position signal that is within an unambiguous signal range related to said steering joint movement range;
means for correlating said steering angle signal of said steering angle sensor with said unambiguous signal range of the integrated angle sensor system based on said angular position signal for determining unambiguous steering angle information from said steering angle signal.

14. A motor vehicle steering system in accordance with claim 13, wherein said angle sensor comprises an integrated angle sensor system having corresponding optical or magnetic transducers and detectors.

15. A motor vehicle steering system in accordance with claim 14, wherein said integrated angle sensor system is arranged in said steering joint of a track rod.

16. A motor vehicle steering system in accordance with claim 15, wherein steering angle signal is ambiguous over a total possible steering range of said steering wheel.

17. A motor vehicle steering system in accordance with claim 15, wherein steering angle signal is unambiguous over a total possible steering range of said steering wheel.

18. A motor vehicle steering system in accordance with claim 16, further comprising a vehicle electronic system receiving said unambiguous steering angle information.
